(19) United States
(12) Patent Application Publication
(10) Pub. No.: US 2025/0140238 A1
(43) Pub. Date: May 1, 2025

(54) METHODS AND SYSTEMS FOR ENHANCING MULTIMODAL CAPABILITIES IN LARGE LANGUAGE MODELS

(71) Applicant: Microsoft Technology Licensing, LLC, Redmond, WA (US)

(72) Inventors: Yashesh GAUR, Redmond, WA (US); Jing PAN, Seattle, WA (US); Zhuo CHEN, Woodinville, WA (US); Jian WU, Bellevue, WA (US); Jinyu LI, Redmond, WA (US); Sunit SIVASANKARAN, Redmond, WA (US)

(21) Appl. No.: 18/590,675

(22) Filed: Feb. 28, 2024

Related U.S. Application Data
(60) Provisional application No. 63/546,891, filed on Nov. 1, 2023.

(51) Int. Cl. G10L 15/06; G06F 40/58; G10L 15/183

(52) U.S. Cl. CPC G10L 15/063; G06F 40/58; G10L 15/183

(57) ABSTRACT

Systems and methods are provided for enhancing the speech modality in a large language model (LLM) and for retaining in-context learning capabilities without overfitting to trained tasks. Systems obtain a first set of training data comprising tuples of a sample of speech combined with synthetically generated pairings of speech comprehension test questions and answers that correspond to the sample of speech and obtain a second set of training data comprising pairings of automatic speech recognition data. Systems generate and align a first set of encodings of the first set of training data and a second set of encodings of the second set of training data. Systems train the LLM on a greater amount of the first set of training data than the second set of training data and use the trained LLM to perform a natural language processing task.

### CROSS REFERENCE TO RELATED APPLICATIONS

This application claims the benefit of and priority to U.S. Provisional Patent Application Ser. No. 63/546,891 filed on Nov. 1, 2023, and entitled “METHODS AND SYSTEMS FOR ENHANCING MULTLIMODAL CAPABILITIES IN LARGE LANGUAGE MODELS,” and which application is expressly incorporated herein by reference in its entirety.

### BACKGROUND

Large Language Models (LLMs) have been a focal point of interest in the field of natural language processing due to their ability to capture intricate semantic relationships within language. These models are typically pre-trained on extensive and diverse sets of data and functionalities, along with corresponding context information, to provide proficiency in understanding and responding to text-based prompts. This ability to learn in context has opened up new avenues for their application in various tasks.

On the other hand, speech processing tasks such as automatic speech recognition (ASR) and speech-to-text translation (S2TT) have traditionally relied on models that are trained on substantial amounts of paired speech-text data for training, which can be resource-intensive and potentially lead to optimization challenges.

Attempts to pair speech model functionality with LLMs have resulted in overfitting LLMs to ASR training with significant degradation of the general contextual abilities of the LLMs. Other attempts to link ASR functionality with LLMs with the building of cascading systems have enabled voice instructions to be transformed into textual prompts, for example. However, these cascading systems do not impart actual speech-to-text functionality to the LLM itself, thereby limiting the functionality to only the transformation of the prompts into text and the replies into speech. These models are not able to process actual speech inputs that are included with the prompts (e.g., identify the speaker of this speech based on their voice profiles, or perform other tasks such as translating a speech into text in a different language).

One reason for this is that speech models are typically trained on task-specific training data and do not possess the ability to perform in-context learning or to apply the speech capabilities they are trained on in a different manner than they were trained. This means that they are not capable of adapting to specific contextual nuances or performing tasks that they have not been explicitly trained for. This limitation has been a longstanding challenge in the field of speech processing.

Recently, there has been growing interest in integrating the speech modality with LLMs. The idea is to leverage the strong language understanding capabilities of LLMs to enhance the performance of speech models. However, aligning the representations of speech and text in a way that allows the LLM to effectively handle speech inputs has been a complex and practically prohibitive feat.

In view of the foregoing, there is a desire to provide improved systems and methods for generating and training LLMs that have the ability to perform natural language processing tasks based on natural language input, including tasks involving speech-to-text, speech-to-text translations, and other speech-related tasks, thereby increasing the versatility and applicability of the LLM.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Disclosed embodiments include systems and methods for enhancing speech modality in a large language model (LLM).

In some aspects, the techniques described herein relate to a method for enhancing speech modality in a large language model (LLM). For example, the method includes obtaining a first set of training data including tuples of a sample of speech combined with synthetically generated pairings of speech comprehension test questions and answers that correspond to the sample of speech, and obtaining a second set of training data including pairings of automatic speech recognition data. Systems then generate and align a first set of encodings of the first set of training data and a second set of encodings of the second set of training data. Next, the LLM is trained a greater amount of the first set of training data than the second set of training data. Finally, systems are able to use the trained LLM to perform a natural language processing task.

In some aspects, the techniques described herein relate to a method for using a large language model (LLM) to perform an unseen task. For example, the method includes obtaining an LLM that was (i) initially trained on a mono-lingual task-independent training dataset, (ii) subsequently trained on a combination of automatic speech recognition training data and speech comprehension training data, and (iii) then fine-tuned using a one-shot training data sample including an input-output pair and instructional prompt representing an unseen task. Systems then provide a new input and new instructional prompt to perform the unseen task on the new input to cause the LLM to generate a corresponding output for the new input. Subsequently, systems are able to generate the corresponding output for the new input based on performing the previously unseen task.

This Summary is provided to introduce a selection of concepts that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments that are illustrated in the appended drawings. Understanding that these drawings depict only typical embodiments and are not, therefore, to be limiting in scope, embodiments will be described and explained with additional specificity and detail through the use of the accompanying drawings in which:

FIGS. 1A-1G illustrate example embodiments of an LLM being trained with ASR training data and SQA training data, and with a greater proportion of SQA training data than ASR training data.

FIGS. 2A-2B illustrate examples of process flow diagrams for training an LLM with ASR training data and SQA training data.

FIG. 3 illustrates an example computing environment in which a computing system incorporates and/or is utilized to perform disclosed aspects of the disclosed embodiments.

### DETAILED DESCRIPTION

Disclosed embodiments include or may be used for training and using a large language model (LLM) to perform speech-related tasks. The training of the LLM includes training the LLM on both training data configured for automatic speech recognition (ASR) tasks and training data configured for speech comprehension test question-answer (SQA) tasks. In particular, training can be performed by training the LLM on a greater amount of the SQA training data than the ASR training data.

Models dedicated to speech processing tasks, such as AST and speech-to-text translation, predominantly adhere to supervised training paradigms. However, in order to train speech models to accomplish specific tasks, it is important to provide the models with large amounts of paired speech-text data. Obtaining large amounts of paired speech-text data can be expensive, in terms of both time and human labor. Additionally, training data configurations using these large amounts of paired speech-text data can potentially lead to optimization challenges (e.g., over-fitting the model for a specific ASR task).

Alternatively, to forego reliance on supervised training, conventional systems that rely on less-costly self-supervision training are not able to adequately train existing models because they lack in-context learning capabilities. Accordingly, when conventional models are trained with self-supervision training data, the models will still require further fine-tuning using supervised data to adapt the models to specific domains and tasks.

In light of the foregoing problems associated with training AST and speech-to-text models, the disclosed embodiments are beneficially directed toward systems and methods that incorporate speech modality with pre-trained foundation text LLMs to achieve improved in-context learning abilities, particularly for new domains and modalities. Thus, the disclosed embodiments provide systems and methods that effectively bridge the gap between speech modality and text-LLM that only require small amounts of instruction-tuning data. To prepare the multi-modal instruction tuning data, a GPT model is prompted to generate comprehension text question-answer pairs based on transcripts of speech samples. In some embodiments, a speech encoder and a text-LLM are trained together to answer questions based on the input speech content. By performing multi-modal instruction tuning using speech data, the disclosed training process evolves the ability of zero-shot text instruction following capability in ASR and zero-shot/few-shot in-context learning to unseen speech translation tasks.

The disclosed embodiments cover a method for fine-tuning an LLM on datasets comprising instruction-output pairings (e.g., instruction tuning). Typically, this fine-tuning is performed as supervised training. Such fine-tuning facilitates the alignment of the model's output when using natural language instruction as part of the input to the model. In other words, the fine-tuning facilitates an improved alignment between the inherent objective or capability of the LLM to predict the next token in the output and the overall human objective for the output as represented in the instruction input. The disclosed embodiments are data-efficient because they facilitate a way to perform this instruction-tuning with limited training data.

In some embodiments, the training architecture comprises a connectionist temporal classification (CTC) compressor, an audio encoder, and an LLM back-bone. CTC refers to a type of neural network output that is used for training recurrent neural networks, such as long-short-term-memory (LSTM) models. CTC techniques are beneficial in tasks such as recognizing phonemes in speech. The CTC compressor is pre-trained on ASR tasks and compresses the acoustic features according to the distribution of the CTC posteriors. The audio encoder learns to bridge the representation from the CTC compressor to the embedding space of the LLM. Finally, the LLM generates the corresponding text conditioned on the given text prompt and audio encoder outputs.

In order to unlock the LLM's strong intrinsic natural language understanding capabilities, the system performs an efficient instruction-tuning method based on speech comprehension tests, which formulates one-to-many mapping from the input speech to the target text. The disclosed embodiments achieve improved efficiency as compared to conventional systems and methods for instruction-tuning, because the disclosed systems and methods utilize generative models to create synthetic training. This synthetic training data is generated faster and less expensively than conventional natural language training data which must be recorded, collected, cleaned, and aggregated. Furthermore, the instruction-tuning is efficient because it can be performed with single or few-shot training, which requires less training data and fewer training iterations than conventional instruction-tuning.

As described in more detail below, the training of the model includes the use of speech, question, answer (SQA) training data with ASR training data. The inclusion of SQA training data with the ASR training data provides a richer and more diverse source of training data for the LLM, as the SQA training data includes a wide range of speech comprehension test questions and answers that are relevant to the content of the speech samples.

When generating the SQA training data, a SQA task uses questions as instructions and allows semantically diverse instructions and target responses. Meanwhile, the model is trained to query information from the input speech to generate corresponding SQA training data, and which enhances the alignment between the speech and text modality on top of the ASR task.

By unlocking the model's speech in-context learning, systems can achieve on-the-fly low-cost adaptation to new domains and modalities with as little as a single audio-text training sample or pairing. Such “on-the-fly” training is achievable because it can be performed during run-time where single-shot training only requires a single audio-text training data pair and as little as a single iteration of training. This is a notable improvement over existing systems that cannot be effectively trained or fine-tuned with only a single-shot training sample, particularly when they have undergone extensive training with ASR training data that has overfit the model to particular ASR tasks, as generally described above.

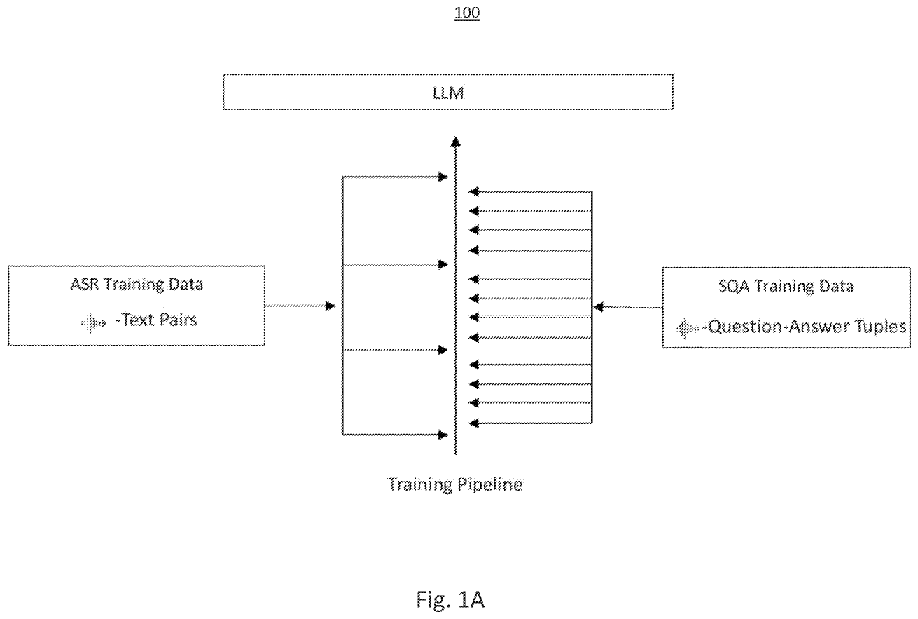

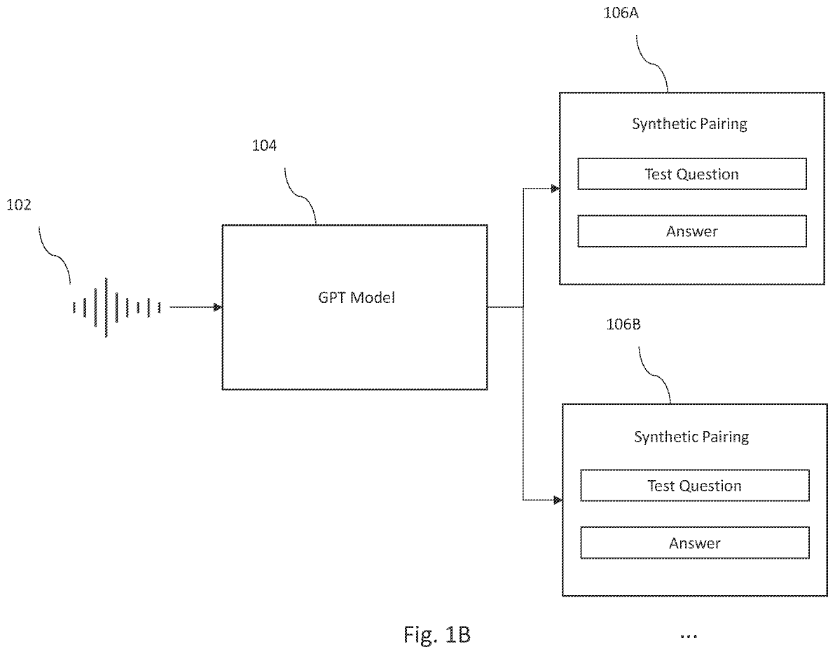

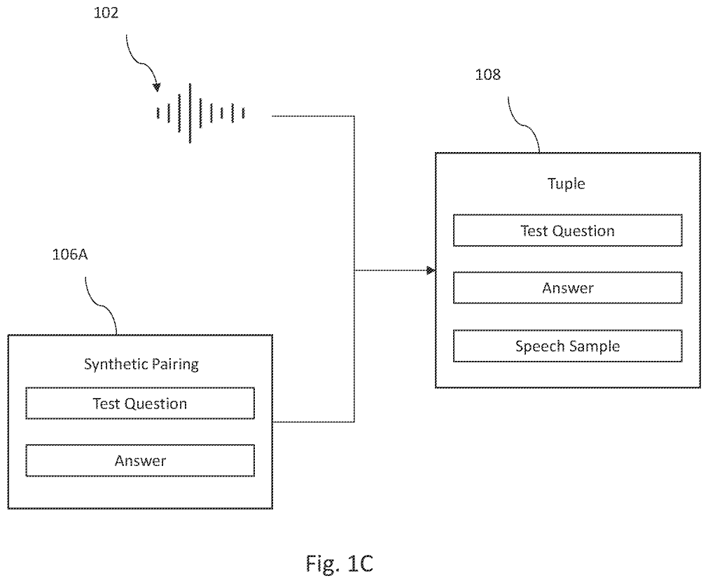

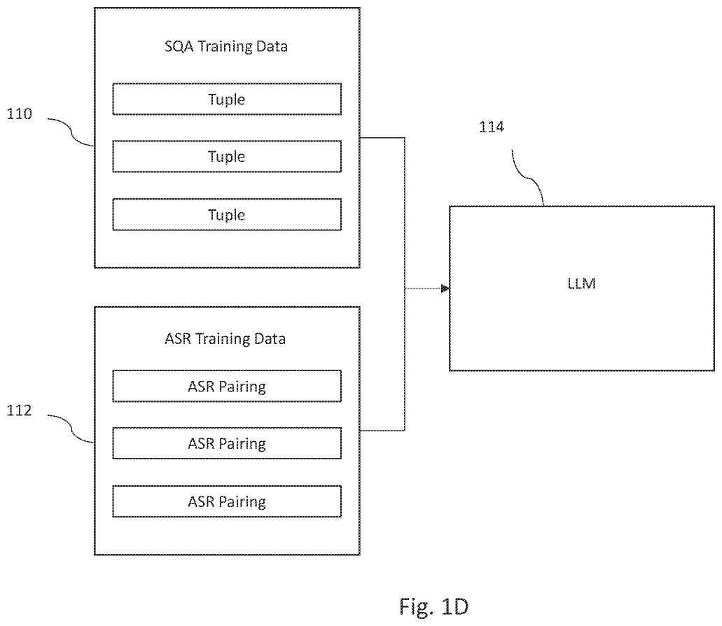

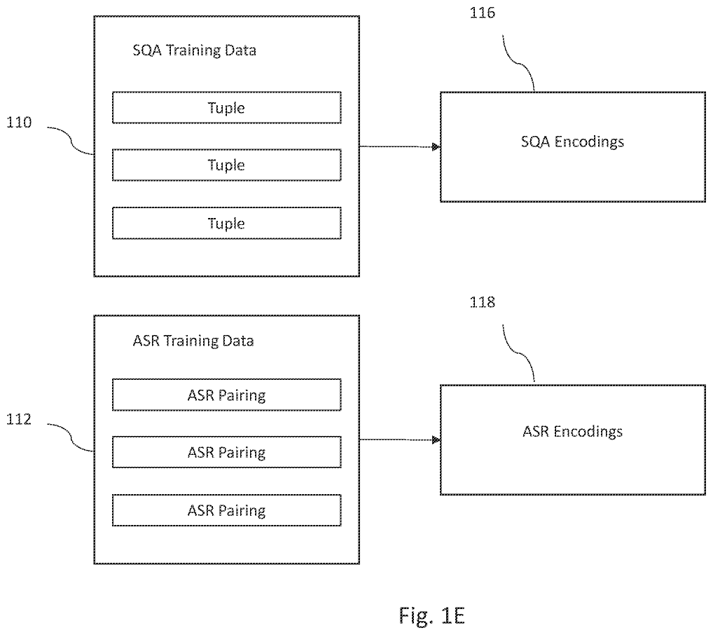

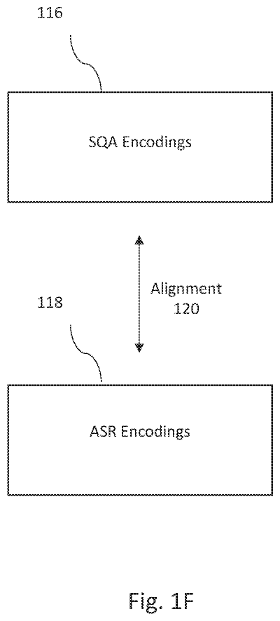

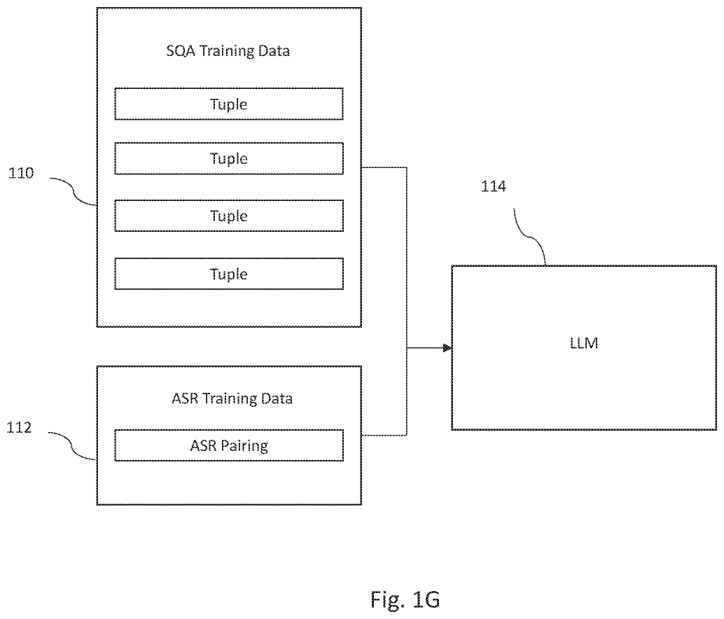

Attention will now be directed to FIGS. 1A-1G, which illustrate example processes of an LLM being trained with ASR training data and SQA training data. In FIG. 1, a training pipeline 100 includes the use of four times the SQA training data as the ASR training data. Preferably, more SQA training data is used than ASR training data. However, the ratio of the training data that is used can be modified. In some instances, the LLM is applied to at least two times the SQA training data than the ASR training data. In other embodiments, the LLM is applied to at least four, eight, sixteen, or more than sixteen times the SQA training data than the ASR training data. As will be described in more detail below, increasing the ratio of SQA training data relative to the ASR training data can significantly reduce the likelihood the model will be overfit to a particular ASR task, while still configuring the model for subsequent fine-tuning to desired tasks, as will also be described.

The exposure of the LLM to more SQA training data than the ASR training data can help prevent the LLM from being overfitted to the ASR training data or any specific speech-related task that the ASR training data corresponds to (e.g., speech-to-text or speech-to-translated text). Although not shown in this illustration, the LLM can also be applied to diverse types of ASR training data sets that are interleaved with the SQA training data.

The LLM is trained in such a manner as to retain in-context capabilities with enhanced speech-processing capabilities. In-context learning refers to a particular behavior of an LLM model that is pre-trained on a large corpus of input/output training data. In-context learning allows a language model to learn specific tasks with only a few pieces of example training data. To take advantage of in-context learning, a model is given a set of input-output pairs that represent a particular task. The model is also provided a test input and is asked to predict the output by only conditioning itself on the input-output pairs; it does not update its parameters, nor does it have to store the new parameters for the new task. Instead, the model conditions itself on the training examples to understand the input distribution, output distribution, input-output mapping, and any formatting.

Thus, once trained, the LLM can be further refined or fine-tuned to perform a specific speech-related task by providing a single prompt (single-shot) with an example of speech to be processed and an example of the processed speech. The speech in this description can be a natural spoken language. Additional contextual examples can also be provided, if desired, as a multiple-shot refinement process. In this manner, in-context learning provides a way to train models for new tasks quickly and efficiently. For example, a text-based LLM can be quickly adapted to the speech modality using its in-context learning capabilities to condition itself on training examples comprising speech-text input/output training pairs.

In some examples, the single prompt includes a sample of speech in one language and the example of the processed speech is a transcription in the same or a different language. In another example, sample speech comprise natural language utterances provided with a noisy background, and the processed speech is a transcript of utterances that omit indications of the noisy background.

In some instances, the prompt comprises a natural language instruction and the processed speech comprises a textual representation of the instruction. In some instances, the prompt is a verbal or textual prompt that references a separate natural language sample appended to the prompt or that is referenced by a file location where the LLM can find the sample.

The disclosed embodiments may be utilized to realize many technical benefits and advantages over conventional systems and methods for training LLMs, including the ability to incorporate natural language speech recognition capabilities and to perform natural language tasks, such as speech-to-text and speech-to-translated text.

This functionality is also provided without overfitting the LLM to any specific speech-related task or ASR training data. For example, conventional methods and systems typically only train on tasks such as automatic speech recognition and speech-to-text. However, when trained on these specific types of tasks, the model tends to over-fit to the trained tasks. This means that the model will not be able to recognize generalized text instructions other than those specifically seen during the training (i.e., instruction tuning for those tasks). Thus, in order to unlock the LLM's strong intrinsic natural language understanding capabilities, the disclosed embodiments are directed to training methods which incorporate speech comprehension tasks that help the model formulate and understand one-to-many mapping from the input speech to target text. The speech comprehension training uses questions as instructions and allows semantically diverse instructions and target responses. Additionally, the model is trained to query information from the input speech during the speech comprehension training, which further enhances the alignment between the speech and text modalities in the model. This alignment is improved over what can be achieved by solely training on standard automatic speech recognition tasks.

Attention will now be directed to FIG. 1B, which illustrates an example embodiment for generating synthetic pairings to be used in SQA training data. In some embodiments, the SQA training data is synthetic training data based on questions and answers that are generated by a GPT model applied to a sample of speech. This may include applying the GPT model (e.g., GPT Model 104) to a transcript of the speech sample (e.g., speech sample 102) or directly to the speech sample, as shown in FIG. 1B. An example of a speech sample may comprise a spoken language utterance such as “It's the Gibraltar strait where you lost control and then you dived down . . . one of those cases where you let the wings go in the clouds but you lose orientation completely . . . .”

This speech sample is transcribed to provide a transcription of the spoken language utterance. This speech sample and/or corresponding transcript is provided to the model (e.g., LLM, GPT, or other types of generative machine learning models), which is prompted to generate question-answer pairs. Some examples of questions that could be generated for speech comprehension include “What happened to them in the clouds?”; “Where did the incident occur?”, or “What happened to the wings?”. The answers to these questions may be “They lost control in the clouds.”; “The incident occurred in the Gibraltar Strait.”; and “They let the wings go into the clouds.”, respectively.

As ASR task instruction may be: “Transcribe the audio to text,” which would use the ASR training data including the pairs of speech samples and corresponding speech transcriptions.

As shown in FIG. 1C, the synthetic/generated questions and answer pairings (e.g., synthetic pairing 106A) that are generated from the speech sample are matched with the corresponding speech sample (e.g., speech sample 102) into a SQA training data tuple (e.g., tuple 108). These tuples provide a one-to-many mapping of the speech sample to different question and answer pairings from the same speech sample. For example, referring back to FIG. 1B, GPT Model 104 is able to generate a plurality of synthetic question-answer pairings (e.g., synthetic pairing 106A, synthetic pairing 106B, etc.) for a single speech sample. It should be appreciated that while FIG. 1B illustrates the GPT Model generating at least two synthetic pairings, the GPT Model is able to generate any number of synthetic pairings. In some embodiments, the GPT Model generates a pre-determined number of synthetic pairings, while in other embodiments, the GPT Model generates synthetic pairings dynamically (e.g., based on a number of ASR training data pairs) or based on feedback from the LLM training. By interleaving speech comprehension training with automatic speech recognition training (and using corresponding training data sets), the disclosed embodiments provide training methods that allow the LLM to maintain its ability to utilize in-context learning by preventing the LLM from being over-fit to the automatic speech recognition task during training.

Notably, the generation and use of the SQA training tuples pairings is performed in a synthetic manner, meaning that the pairings are generated by the GPT without the involvement of human annotators that typically annotate the labels for the speech components of the training data. This makes the generation process scalable and cost-effective, as it does not require the manual annotation of speech data.

It is also notable that of the one-to-many nature of the SQA training data serves as a rich source of context and inference training data for the LLM, enabling it to learn to process and understand speech inputs in the context of the corresponding text inputs.

Attention will now be directed to FIG. 1D, which illustrates an example embodiment for training an LLM. For example, as part of the LLM training, systems are also configured to generate and/or obtain ASR training data (e.g., ASR training data 112) comprising a plurality of ASR pairings. Preferably, the ASR training data pairings are used to train the LLM in a supervised manner. During the training process, the LLM is presented with a speech input and its corresponding transcription. The LLM processes the speech input and generates a transcription based on its current understanding of the speech-to-text mapping. The generated transcription is then compared with the ground truth transcription, and the difference between the two serves as a measure of the LLM's performance. The parameters of the LLM are adjusted in a way that minimizes this difference, thereby improving the LLM's ability to accurately transcribe speech inputs into text.

It is worth noting that the process of obtaining pairings of ASR training data is not a one-time activity. As the LLM continues to learn and evolve, new ASR training data pairings may be obtained and added to the training dataset. This continuous updating of the training dataset helps to ensure that the LLM remains up-to-date with the latest trends and variations in speech patterns, thereby enhancing its performance and adaptability. Similarly new SQA training data will be interleaved with the ASR training data that the LLM is applied to ensure that the LLM maintains proficiency at contextual analysis and inference.

Importantly, as shown in FIG. 1D, the LLM is applied to both the SQA training data (e.g., SQA training data 110) and the ASR training data 112. This joint training also involves a series of steps that are designed to align the representations of the SQA training data and the ASR training data with the LLM, as shown in FIGS. 1E-1G, described below.

FIG. 1E illustrates an example embodiment for generating encodings of different training data. The first step in this process is the generation of encodings of the SQA training data and the ASR training data. For example, a plurality of SQA encodings (e.g., SQA encodings 116) is generated for the SQA training data 110, and a plurality of ASR encodings (e.g., ASR encodings 118) is generated for the ASR training data 112. The different encodings are generated by providing the respective training datasets to the LLM as input and causing the LLM to generate the encodings as model output. The LLM processes the training data and generates a set of encodings that represent the content of the training data in a form that the LLM can understand and process. These encodings serve as a bridge between the raw training data and the internal representations used by the LLM.

In FIG. 1F, an example embodiment is provided for aligning the different encodings (e.g., Alignment 120) For example, as illustrated, the SQA encodings 116 are aligned with the ASR encodings 118. In some embodiments, the SQA encoding 116 and the ASR encodings 118 are aligned by adjusting the parameters of the LLM to minimize the difference between the encodings of the different sets of training data and the internal representations of the training data used by the LLM. It should be appreciated that there are different alignment techniques available, including aligning the training data with outputs of the LLM model, or using intermediate hidden states of the LLM model. This alignment process is a form of fine-tuning that is designed to enhance the LLM's ability to accurately process and understand the training data.

After the alignment process, the SQA training data and the ASR training data are provided to the LLM as inputs (e.g., the LLM is applied to the different training datasets) train the LLM. In other words, the LLM is trained on both the SQA training data and the ASR training data. However, as previously noted, the LLM is preferably trained on a greater amount of the SQA training data than the ASR training data, as reflected in FIG. 1G. For instance, as shown, the SQA training data 110 comprises four times the amount of training data as the ASR training data 112. It will be appreciated that while FIG. 1G illustrates a ratio of 4:1, any ratio between the SQA training data 110 and ASR training data 112 may be used, so long as the SQA training data is more predominantly used than the ASR training data in the training data pairings. (e.g., 2:1, 8:1, 16:1, etc.)

It is desirable to use more SQA training data than ASR training data when tuning the LLM because it has been found that the SQA training data provides a richer and more diverse source of training data for the LLM. The SQA training data is particularly beneficial because it includes a wide range of speech comprehension test questions and answers that are relevant to the content of the speech samples. By applying the LLM to a greater proportion of the SQA training data, the LLM is able to learn to process and understand a wider range of speech inputs, thereby enhancing its performance in tasks that involve speech modality.

After the joint training process, the LLM can also be fine-tuned to perform a specific speech-to-text task with a single-shot training prompt. Because of the joint training described above, in which the model retains its in-context learning capabilities without overfitting to the ASR task, the model is able to be quickly adapted to a new task that was not represented in either the SQA or ASR training datasets, nor represented in its original general training corpus. For example, in some instances, after the joint SQA and ASR training, a user may wish to fine-tune the model for a speech-to-text translation task, such as translating English speech to non-English text (e.g., Spanish, German, etc.) In a zero-shot method, the model is simply provided an English speech audio sample and a prompt comprising instructions to “Translate the audio into Spanish”. In a 1-shot training method, the model is provided a randomly selected English speech audio sample, the corresponding text translation in Spanish (or desired target language), and an instructional prompt to translate the English audio sample into Spanish text.

The one-shot trained LLM surpasses both the zero-shot trained LLM and an ASR-only trained LLM (i.e., no SQA training was performed) when scored according to the Bilingual Evaluation Understudy (BLEU) algorithm, a standard for determining the quality of machine-translated output. This improved BLEU score, especially in the one-shot trained or fine-tuned LLM demonstrates the efficacy of the in-context learning ability in the jointly trained LLM described herein. This is because while none of the previous datasets were configured for speech-to-text translation, nor included non-English speech or text, using a single input-output (e.g., English audio and non-English target language text) and an instructional prompt, the model was then able to provide high quality machine translation output in the non-English target language for new English audio that it had never seen before in any of its previous training datasets.

This fine-tuning process is a valuable step in enhancing the LLM's ability to handle and process speech inputs. The single-shot training prompt serves as a guide for the LLM, directing it towards the specific task that it is expected to perform. This prompt is provided in the form of a natural language input, which is a form of input that the LLM is inherently designed to understand and process.

The natural language input used as a prompt can take various forms, depending on the specific speech-to-text task that the LLM is being fine-tuned to perform. For instance, the prompt could be a simple instruction such as “transcribe the following speech”, or it could be a more complex instruction that requires the LLM to perform a specific task such as “translate the following speech into Spanish”. The flexibility of the natural language input allows for a wide range of speech-to-text tasks to be performed by the LLM.

In addition to the zero-shot and single-shot scenario, just described, it is also possible to apply the LLM to tasks a few-shot scenario, where a few examples are provided. With more training examples provided in the few-shot scenario, the LLM achieves increased quality in providing outputs for the fine-tuning tasks, such as speech-to-text translation or even speech domain adaptation. For example, using the few-shot scenario, the LLM is able to be quickly and efficiently fine-tuned to perform multi-lingual speech-to-text translation for multiple different target languages, by providing as little as a single input-output training example for each desired target language. Thus, after baseline, generalized training, and the subsequent joint training (i.e., instruction-tuning training or SQA and ASR training), the LLM can be fine-tuned to a new multi-modal (i.e., speech and text) task using the zero-shot, one-shot, or few-shot training methods described above for one or more new tasks.

The process of converting a sample of audio into a translated text is a complex task that requires the LLM to accurately capture the semantic content of the audio, while also dealing with various challenges such as background noise, speaker accents, and speech variations. Despite these challenges, the LLM is able to perform this task with a high degree of accuracy, thanks to the joint training process and the use of synthetic pairings of speech comprehension test questions and answers.

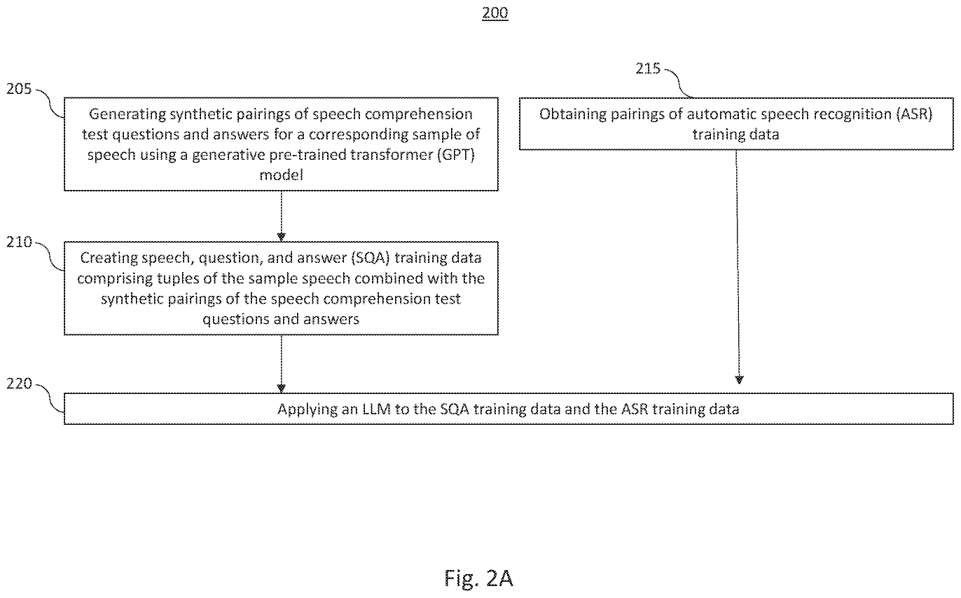

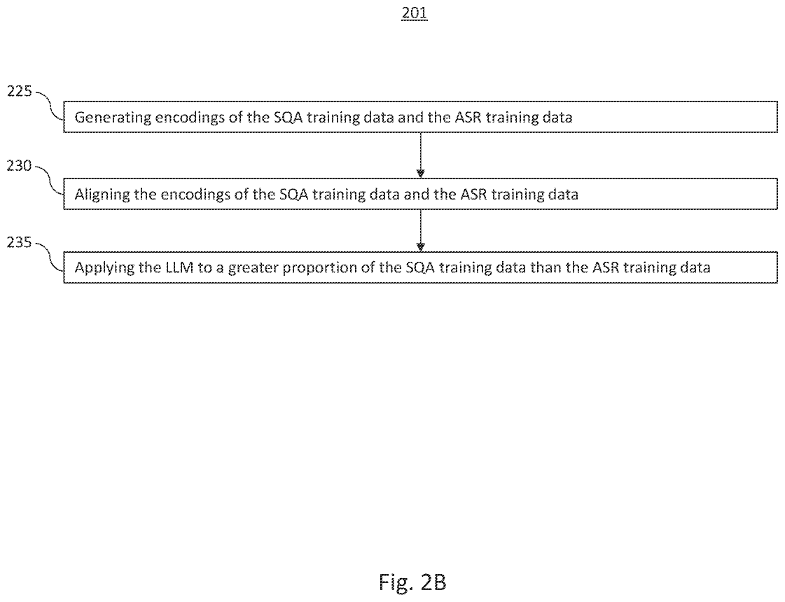

Attention will now be directed to FIGS. 2A-2B with references to FIGS. 1A-1G, which illustrates an example of a process flow diagram 200 and process flow diagram 201 comprising acts (e.g., act 205, act 210, act 215, act 220, act 225, act 230, and act 235)) associated with methods for enhancing speech modality in a large language model that previously only exhibited text modality capabilities. A first illustrated act includes generating synthetic pairings (e.g., synthetic pairing 106A, synthetic pairing 106B) of speech comprehension test questions and answers for a corresponding sample of speech (e.g., speech sample 102) using a generative model (e.g., such as GPT Model 104) (act 205). Generating synthetic pairings for the SQA training data is more efficient than manually generating synthetic pairings and thus saves time and the need for human intervention, which can be costly in terms of time and money. Additionally, by using the generative model to generate the synthetic pairings, the system can quickly generate large amounts of training data with unique datasets. Furthermore, by using the generative model, the system beneficially is able to generate a one-to-many mapping for each speech sample, thus reducing the number of speech samples that are needed while also providing a robust set of synthetic pairings that covers many different potential questions and answers. For example, for limited audio data and/or text data, the system is able to generate large quantities of speech comprehension question-answer training examples.

Accordingly, systems are also configured for creating Speech, Question and Answer (SQA) training data comprising tuples (e.g., tuple 108) of the sample of speech combined with the synthetic pairings of the speech comprehension test questions and answers (act 210). By combining the synthetic pairing with the corresponding speech sample, the system is beneficially able to create a higher quality training data set by creating training data that is now correlated between the synthetic pairings and the respective speech samples.

In addition to creating the set of tuples, the systems obtain pairings of automatic speech recognition (ASR) training data (e.g., ASR training data 112) (act 215). By obtaining ASR training data, the system is able to train the parameters of the LLM on multiple tasks and provide breadth of training. Finally, systems train the LLM (e.g., LLM 114) on the SQA training data and the ASR training data (act 220). By training the LLM on both the SQA training and the ASR training, the trained LLM is able to achieve improved performance in both SQA tasks and ASR tasks. For example, the LLM is able to achieve instruction-following and in-context learning capabilities in speech-to-text tasks, without being overfit to the ASR task specifically.

Notably, as shown in FIG. 2B, the application of the LLM to the SQA and ASR training data includes at least: generating encodings of the SQA training data (e.g., SQA encodings 116) and encodings of the ASR training data (e.g., ASR encodings 118) (act 225), aligning (e.g., alignment 120) encodings of the SQA training data and the ASR training data with the LLM (act 230). By generating encodings of the different training datasets, the different formats of the SQA training data and ASR training data can be mapped to a shared representation space, thereby enabling and facilitating an improvement in the subsequent alignment of the different datasets which is achieved by aligning the encodings of the respective training datasets.

In some embodiments, the LLM is trained on a greater amount of SQA training data than ASR training data (act 235). By training the LLM on a greater amount of the SQA training data than the ASR training data (e.g., as shown in FIG. 1G) prevents the model from being overfit to the ASR task and thus unable to be fine-tuned to new tasks in subsequent fine-tuning training processes. As described above, the SQA training data provides a richer and more diverse source of training data for the LLM, as it includes a wide range of speech comprehension test questions and answers that are relevant to the content of the speech samples.

It is worth noting that the specific proportion of the SQA training data to the ASR training data that the LLM is trained on can be adjusted based on the specific requirements of the task at hand. This flexibility in the proportion of the SQA training data to the ASR training data allows the joint training process to be tailored to the specific requirements of the task, thereby enhancing the effectiveness and efficiency of the joint training process. For example, in some instances, the LLM may be primarily used for ASR tasks, in which the ratio between SQA data and ASR data may be reduced in order to provide additional training for the ASR training task.

Although not shown, these acts may further include fine-tuning the LLM to perform a specific speech-to-text task with a single-shot training prompt that may comprise or reference natural language input. For instance, the prompt may comprise a natural language input/utterance as an instruction that is interpreted by the LLM. Additionally, or alternatively, the natural language input of the prompt may reference or include a speech or audio sample to be processed as well as a sample of the processed audio sample (in audio or text form).

Thereafter, the LLM is configured to perform a speech-to-text task or other speech-related task associated with the context of the prompt, even though the LLM was not specifically applied to large training data sets for performing that type of task and that would typically be required to perform the speech-related task with any valuable proficiency.

In some instances, the task is a speech-to-text task comprised of converting a sample of audio into a translated text. In another example, the task is a speech-to-translated text task that the LLM model is refined to do based on receiving a single instance of a speech sample and a translated text of that speech sample. Thereafter, the LLM can translate other speech samples into text when those new speech samples are provided in new prompts to the LLM.

In some instances, the synthetic speech comprehension test questions and answers are generated based on transcripts of a sample of speech provided to a GPT rather than actual speech utterances.

The synthetic speech comprehension test questions and answers form a one-to-many mapping from input speech to target text, thereby enhancing alignment between the speech modality and the text modality of the LLM trained on that SQA training data such that the LLM is capable of performing unseen tasks in a zero-shot setting, one-shot setting, or few-shot setting. Unseen tasks refer to tasks that are not represented in the previous training datasets. For example, because of the robust mapping learned from the SQA training data, the LLM is able to be fine-tuned to perform speech-to-text translation from English speech to non-English machine translated text, even though the previous datasets (e.g., SQA and ASR training datasets) did not include any examples for the machine translation task.

However, as mentioned earlier, one example prompt (single-shot setting) can be provided or, alternatively, a few example prompts (few-shot setting) can be provided to the LLM to further fine-tune the LLM to perform an unseen tasks (i.e., tasks that the LLM was not initially trained on) with a relatively high degree of proficiency, outperforming cascading models built with sequentially linked ASR+LLM modules. The disclosed jointly-trained model performance was compared against baseline models, including a cascaded system comprising an ASR module and an LLM module, as well as a baseline model comprising an LLM trained solely on ASR training data. For the machine translation task performance, the models were measured according to the BLEU measurement scale.

The following table depicted below (e.g., Table 4) shows the results for the various models. Notably, the Cascaded (7B) model and the COSMIC-7B-asr models are the baseline models described above. The COSMIC-7B (with 16.1 million trainable parameters) and COSMIC-13B (with 17.3 million trainable parameters) represent different versions of a SQA and ASR jointly-trained LLM described herein. Each model is scored based on a 0-shot and 1-shot fine-tuning for the machine translation task, for previously unseen target languages (e.g., Spanish (Es), French (Fr), and German (De)).

TABLE 4
In-domain EN→X S2TT on TED-LIUM 3 test sets

| | | EN→X Target | | |
|---|---|---|---|---|
| Model | #Example | Es | Fr | De |
| Cascaded(7B) | 0-shot | 26.07 | 22.61 | 15.53 |
| COSMIC-7B-asr | 0-shot | 2.53 | 2.32 | 2.77 |
| | 1-shot | 2.04 | 2.32 | 4.78 |
| COSMIC-7B | 0-shot | 17.13 | 20.88 | 15.45 |
| | 1-shot | 28.89 | 26.45 | 19.18 |
| COSMIC-13B | 0-shot | 8.59 | 13.24 | 10.12 |
| | 1-shot | 30.57 | 28.41 | 21.36 |

As shown in the table, the Cascaded system scores better BLEU than the COSMIC-7B 0-shot, because the alignment process never introduces new data in foreign languages. However, notably, the COSMIC-7B 1-shot results surpass the Cascaded system, proving the efficacy of the speech in-context learning that was retained in the model due to the joint SQA and ASR training regime. Additionally, the COSMIC-7B-asr is inferior to both the 0-shot and 1-shot of the COSMIC 7B and COSMIC 13B, confirming that the SQA training, along with the ASR training, is key in providing the higher quality results. Furthermore, it should be appreciated that the COSMIC 13B, in the 1-shot version, performs the best among all languages.

This joint-training and additional fine-tuning (either zero-shot, one-shot, or few-shot fine-tuning) also enables the LLM to be trained to perform domain adaptation, alternatively, or additionally to machine translation. Domain adaptation refers to the ability of the LLM to adapt its responses based on the specific domain or context of the speech input. This is particularly useful in scenarios where the speech input may contain domain-specific terminology or concepts that the LLM has not been explicitly trained for.

For example, a jointly-trained LLM may be fine-tuned to be adapted to a new text corpus (e.g., LibriSpeech) which was not included in any of the previous training datasets. As an example for the one-shot setting, during inference, the system randomly selects a single utterance with a transcription from the new text corpus and supplies the utterance and corresponding transcription as the one-shot example to the LLM. This 1-shot example provides limited context information (e.g., vocabulary distribution, topics). Using the one-shot training method for the domain adaptation task, the LLM (previously trained on the SQA and ASR training data) is able to achieve improved word error rates (WERs) over baseline models. For example, COSMIC-7B was able to achieve WERs of 21.15 in the zero-shot setting and 12.16 in the 1-shot setting.

In the domain adaptation process, the LLM is provided with a single audio example and its corresponding text target. The audio example serves as a representative sample of the domain, providing the LLM with a context for understanding the domain-specific aspects of the speech input. The corresponding text target provides the LLM with a reference for generating accurate responses in the context of the domain. By processing the audio example and text target, the LLM is able to align its internal representations with the domain-specific aspects of the speech input, thereby enhancing its ability to generate accurate responses in the context of the domain.

As described, the training and use of an LLM in this manner can greatly enhance the LLM for speech modality. The joint training of the LLM with ASR training data and SQA training data improves the LLM's ability to handle and process speech inputs, thereby enhancing its overall performance in tasks that involve speech modality.

Thus, the disclosed embodiments achieve an improved quality of results both for seen and unseen tasks as compared to conventional LLMs. Conventional LLMs refer to language models that are characterized by their ability to provide generative (i.e., predictive output) as well as perform natural language processing and understanding tasks. LLMs generally comprise neural networks (e.g., such as recurrent neural networks), typically built in a transformer-based configuration. Conventional or baseline LLMs (e.g., generative pre-trained transformers such as GPT-3) typically are only trained on either a generalized, task-independent training corpus or a combination of the generalized, task-independent training corpus and an ASR training dataset to train the model on ASR tasks. However, as described above, such models perform poorly when attempts are made to adapt them to unseen tasks which were not represented in their previously seen training data.

### Example Computing Systems

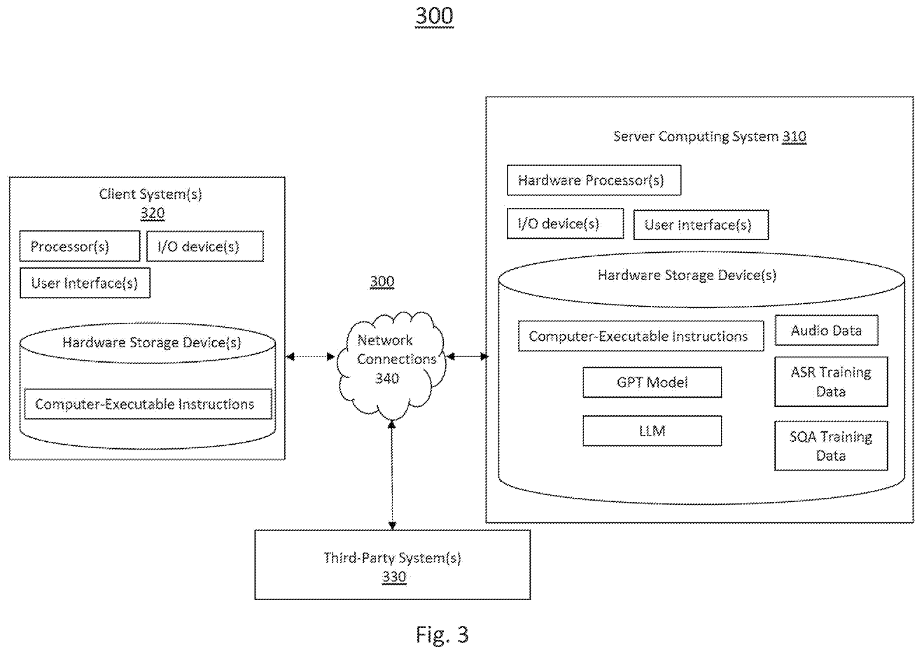

Attention will now be directed to FIG. 3, which illustrates the computing system 310 as part of a computing environment 300 that includes client system(s) 320 and third-party system(s) 330 in communication (via a network 340) with the computing system 310. As illustrated, computing system 310 is a server computing system configured to access and modify an LLM with ASR training data and SQA training data, as described herein.

The computing system 310, for example, includes one or more processor(s) (such as one or more hardware processor(s) and one or more hardware storage device(s) or hardware storage system storing computer-readable instructions. One or more of the hardware storage device(s) is able to house any number of data types and any number of computer-executable instructions by which the computing system 310 is configured to implement one or more aspects of the disclosed embodiments when the computer-executable instructions are executed by the one or more hardware processor(s). The computing system 310 is also shown including user interface(s) and input/output (I/O) device(s).

As shown in FIG. 3, hardware storage device(s) are shown as a single storage unit. However, it will be appreciated that the hardware storage device(s) can also be a distributed storage that is distributed to several separate and sometimes remote systems and/or third-party system(s). The computing system 310 can also comprise a distributed system with one or more of the components of computing system 310 being maintained/run by different discrete systems that are remote from each other and that each system performs different tasks. In some instances, a plurality of distributed systems performs similar and/or shared tasks for implementing the disclosed functionality, such as in a distributed cloud environment.

In some instances, the audio data is natural language audio and/or synthesized audio data. Input audio data is retrieved from previously recorded files such as video recordings having audio or audio-only recordings. Some examples of recordings include videos, podcasts, voicemails, voice memos, songs, etc. Audio data is also retrieved from actively streaming content which is live continuous speech such as a news broadcast, phone call, virtual or in-person meeting, etc. In some instances, a previously recorded audio file is streamed. Natural audio data is recorded from a plurality of sources, including applications, meetings comprising one or more speakers, ambient environments including background noise and human speakers, etc. It should be appreciated that natural language audio comprises one or more spoken languages of the world's spoken languages. Thus, the models described herein are trainable in one or more languages.

The ASR training data comprises spoken language utterances (e.g., natural language and/or synthesized speech) and corresponding textual transcriptions (e.g., text data). The training data comprises text data and natural language audio and simulated audio that comprises speech utterances corresponding to words, phrases, and sentences included in the text data. In other words, the speech utterances are the ground truth output for the text data input.

The server computing system is in communication with client system(s) 320 comprising one or more processor(s), one or more user interface(s), one or more I/O device(s), one or more sets of computer-executable instructions, and one or more hardware storage device(s).

The server computing system is also in communication with third-party system(s) 330. It is anticipated that, in some instances, the third-party system(s) 330 further comprise databases housing data that could be used as training data, for example, text data not included in local storage. Additionally, or alternatively, the third-party system(s) 330 includes machine learning systems external to the computing system 310.

The server computing system may obtain any of the referenced training data and models from the client system and/or third-party systems. The server computing system may also obtain prompts from the client and third-party systems for fine-tuning the LLM, as described herein, such as in a one-shot or multiple shot prompt fine-tuning process.

Embodiments of the present invention may comprise or utilize a special-purpose or general-purpose computer (e.g., computing system 310) including computer hardware, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media (e.g., hardware storage device(s)) that store computer-executable/computer-readable instructions are physical hardware storage media/devices that exclude transmission media. Computer-readable media that carry computer-executable instructions or computer-readable instructions in one or more carrier waves or signals are transmission media. Thus, by way of example, and not limitation, embodiments of the invention can comprise at least two distinctly different kinds of computer-readable media: physical computer-readable storage media/devices and transmission computer-readable media.

Physical computer-readable storage media/devices are hardware and include RAM, ROM, EEPROM, CD-ROM or other optical disk storage (such as CDs, DVDs, etc.), magnetic disk storage or other magnetic storage devices, or any other hardware which can be used to store desired program code means in the form of computer-executable instructions or data structures and which can be accessed by a general purpose or special purpose computer.

A “network” (e.g., network 340) is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links that can be used to carry, or desired program code means in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

### Numbered Clauses

The present invention can also be described in accordance with the following numbered clauses.

Clause 1. A method for enhancing speech modality in a large language model (LLM), the method comprising: obtaining a first set of training data comprising tuples of a sample of speech combined with synthetically generated pairings of speech comprehension test questions and answers that correspond to the sample of speech; obtaining a second set of training data comprising pairings of automatic speech recognition data; generating a first set of encodings of the first set of training data and a second set of encodings of the second set of training data; aligning the first set of encodings and the second set of encodings with the LLM; training the LLM on a greater amount of the first set of training data than the second set of training data; and using the trained LLM to perform a natural language processing task.

Clause 2. The method of clause 1, wherein the natural language processing task comprises a speech-to-text task and wherein the method further comprises: fine-tuning the LLM to perform the specific natural language processing task with a single-shot training prompt.

Clause 3. The method of clause 2, wherein the single-shot training prompt comprises a natural language input.

Clause 4. The method of clause 3, wherein the natural language input comprises a speech or audio sample provided as a reference with the prompt.

Clause 5. The method of clause 2, wherein the speech-to-text task comprises converting a sample of audio into a translated text.

Clause 6. The method of clause 1, further comprising: generating the synthetic speech comprehension test questions and answers based on transcripts of the sample of speech using a generative machine learning model.

Clause 7. The method of clause 1, wherein the synthetic speech comprehension test questions and answers form a one-to-many mapping from input speech to target text, thereby enhancing alignment between the speech modality and the text modality.

Clause 8. The method of clause 1, wherein the LLM is fine-tuned to perform unseen tasks in a zero-shot setting.

Clause 9. The method of clause 1, wherein the LLM is fine-tuned to perform unseen tasks in a few-shot setting.

Clause 10. The method of clause 1, wherein the LLM is fine-tuned to perform domain adaptation based on a single audio example and corresponding text target.

Clause 11. The method of clause 1, wherein the LLM is applied to at least two times the SQA training data than the ASR training data.

Clause 12. The method of clause 1, wherein the LLM is applied to at least four times the SQA training data than the ASR training data.

Clause 13. The method of clause 1, wherein the LLM is applied to at least sixteen times the SQA training data than the ASR training data.

Clause 14. A system comprising: one or more processors; and a hardware storage system storing computer-executable instructions that are executable by the one or more processors for causing the system to perform a method for enhancing speech modality in a large language model (LLM), the method comprising: obtaining a first set of training data comprising tuples of a sample of speech combined with synthetically generated pairings of speech comprehension test questions and answers that correspond to the sample of speech; obtaining a second set of training data comprising pairings of automatic speech recognition data; generating a first set of encodings of the first set of training data and a second set of encodings of the second set of training data; aligning the first set of encodings and the second set of encodings with the LLM; training the LLM on a greater amount of the first set of training data than the second set of training data; and using the trained LLM to perform a natural language processing task.

Clause 15. The system of clause 14, wherein the natural language processing task comprises a speech-to-text task and wherein the method further comprises: fine-tuning the LLM to perform the specific natural language processing task with a single-shot training prompt.

Clause 16. The system of clause 15, wherein the prompt comprises a natural language input.

Clause 17. The system of clause 16, wherein the natural language input comprises a speech or audio sample provided as a reference with the prompt.

Clause 18. The system of clause 14, wherein the synthetic speech comprehension test questions and answers form a one-to-many mapping from input speech to target text, thereby enhancing alignment between the speech modality and the text modality.

Clause 19. The system of clause 14, wherein the LLM is fine-tuned to perform unseen tasks in a zero-shot setting.

Clause 20. The system of clause 14, wherein the LLM is fine-tuned to perform domain adaptation based on a single audio example and corresponding text target.

Clause 21. A method for using a large language model (LLM) to perform an unseen task, the method comprising: obtaining an LLM that was (i) initially trained on a mono-lingual task-independent training dataset, (ii) subsequently trained on a combination of automatic speech recognition training data and speech comprehension training data, and (iii) then fine-tuned using a one-shot training data sample comprising an input-output pair and instructional prompt representing an unseen task; providing a new input and new instructional prompt to perform the unseen task on the new input to cause the LLM to generate a corresponding output for the new input; and generate the corresponding output for the new input based on performing the previously unseen task.

Clause 22. The method of clause 21, wherein the unseen task is machine translation of audio in a first language represented in the mono-lingual task-independent training dataset and combination of automatic speech recognition training data and speech comprehension training data to a text-based transcription in a second language represented in the output of the one-shot training data sample.

Clause 23. The method of clause 21, wherein the unseen task is domain adaptation to a new domain represented in the one-shot training data sample that is different than a previously seen domain represented in the mono-lingual task-independent training dataset.

What is claimed is:

1. A method for enhancing speech modality in a large language model (LLM), the method comprising:
obtaining a first set of training data comprising tuples of a sample of speech combined with synthetically generated pairings of speech comprehension test questions and answers that correspond to the sample of speech;
obtaining a second set of training data comprising pairings of automatic speech recognition data;
generating a first set of encodings of the first set of training data and a second set of encodings of the second set of training data;
aligning the first set of encodings and the second set of encodings with the LLM;
training the LLM on a greater amount of the first set of training data than the second set of training data; and
using the trained LLM to perform a natural language processing task.

2. The method of claim 1, wherein the natural language processing task comprises a speech-to-text task and wherein the method further comprises: fine-tuning the LLM to perform the specific natural language processing task with a single-shot training prompt.

3. The method of claim 2, wherein the single-shot training prompt comprises a natural language input.

4. The method of claim 3, wherein the natural language input comprises a speech or audio sample provided as a reference with the prompt.

5. The method of claim 2, wherein the speech-to-text task comprises converting a sample of audio into a translated text.

6. The method of claim 1, further comprising: generating the synthetic speech comprehension test questions and answers based on transcripts of the sample of speech using a generative machine learning model.

7. The method of claim 1, wherein the synthetic speech comprehension test questions and answers form a one-to-many mapping from input speech to target text, thereby enhancing alignment between the speech modality and the text modality.

8. The method of claim 1, wherein the LLM is fine-tuned to perform unseen tasks in a zero-shot setting.

9. The method of claim 1, wherein the LLM is fine-tuned to perform unseen tasks in a few-shot setting.

10. The method of claim 1, wherein the LLM is fine-tuned to perform domain adaptation based on a single audio example and corresponding text target.

11. The method of claim 1, wherein the LLM is applied to at least two times the SQA training data than the ASR training data.

12. The method of claim 1, wherein the LLM is applied to at least four times the SQA training data than the ASR training data.

13. The method of claim 1, wherein the LLM is applied to at least sixteen times the SQA training data than the ASR training data.

14. A system comprising:
one or more processors; and
a hardware storage system storing computer-executable instructions that are executable by the one or more processors for causing the system to perform a method for enhancing speech modality in a large language model (LLM), the method comprising:
obtaining a first set of training data comprising tuples of a sample of speech combined with synthetically generated pairings of speech comprehension test questions and answers that correspond to the sample of speech;
obtaining a second set of training data comprising pairings of automatic speech recognition data;
generating a first set of encodings of the first set of training data and a second set of encodings of the second set of training data;
aligning the first set of encodings and the second set of encodings with the LLM;
training the LLM on a greater amount of the first set of training data than the second set of training data; and
using the trained LLM to perform a natural language processing task.

15. The system of claim 14, wherein the natural language processing task comprises a speech-to-text task and wherein the method further comprises: fine-tuning the LLM to perform the specific natural language processing task with a single-shot training prompt.

16. The system of claim 15, wherein the prompt comprises a natural language input.

17. The system of claim 16, wherein the natural language input comprises a speech or audio sample provided as a reference with the prompt.

18. The system of claim 14, wherein the synthetic speech comprehension test questions and answers form a one-to-many mapping from input speech to target text, thereby enhancing alignment between the speech modality and the text modality.

19. The system of claim 14, wherein the LLM is fine-tuned to perform unseen tasks in a zero-shot setting.

20. The system of claim 14, wherein the LLM is fine-tuned to perform domain adaptation based on a single audio example and corresponding text target.

21. A method for using a large language model (LLM) to perform an unseen task, the method comprising:
obtaining an LLM that was (i) initially trained on a mono-lingual task-independent training dataset, (ii) subsequently trained on a combination of automatic speech recognition training data and speech comprehension training data, and (iii) then fine-tuned using a one-shot training data sample comprising an input-output pair and instructional prompt representing an unseen task;
providing a new input and new instructional prompt to perform the unseen task on the new input to cause the LLM to generate a corresponding output for the new input; and
generate the corresponding output for the new input based on performing the previously unseen task.

22. The method of claim 21, wherein the unseen task is machine translation of audio in a first language represented in the mono-lingual task-independent training dataset and combination of automatic speech recognition training data and speech comprehension training data to a text-based transcription in a second language represented in the output of the one-shot training data sample.

23. The method of claim 21, wherein the unseen task is domain adaptation to a new domain represented in the one-shot training data sample that is different than a previously seen domain represented in the mono-lingual task-independent training dataset.
